(19) United States
(12) Patent Application Publication
(10) Pub. No.: US 2020/0291604 A1
(43) Pub. Date: Sep. 17, 2020

(54) SCREENING BUCKET

(71) Applicant: CANGINI BENNE S.R.L., Sarsina (FC) (IT)

(72) Inventor: Giorgio CANGINI, Mercato Saraceno (FC) (IT)

(21) Appl. No.: 15/776,190

(22) PCT Filed: Nov. 16, 2016
(86) PCT No.: PCT/IB2016/056900

§ 371 Date: May 15, 2018

(30) Foreign Application Priority Data
Nov. 17, 2015 (IT) UB2015A005668

(51) Int. Cl. E02F 7/06; B07B 1/00; B07B 1/26

(52) U.S. Cl. CPC E02F 7/06; B07B 1/26; B07B 1/005

(57) ABSTRACT

Screening bucket (100) provided of a screening basket (1) comprising a first cylindrical body (30) having a central axis (51) and a plurality of first holes (32); an actuating unit (50) being provided to rotate the first cylindrical body (30) around the central axis (51); a second cylindrical body (60) being coupled to the first cylindrical body (30) in a longitudinally free and angularly fixed manner; the second cylindrical body (60) having a plurality of second holes (62) facing the first holes (32); an actuating unit (50) being arranged between the first and the second cylindrical bodies (30) (60) to move them longitudinally relative to each other.

The present invention relates to a screening bucket. In particular, the present invention relates to a screening bucket that can be actuated by means of an articulated arm of an earthwork machine. In more detail, the present invention relates to a screening bucket that can be actuated by means of an articulated arm of an earthwork machine in order to separate elements of different sizes from heterogeneous excavated material.

### BACKGROUND TO THE INVENTION

As known, screening buckets are excavating equipment that, coupled to the end of an excavating arm, allow to take heterogeneous material and to select it, separating the fine fractions from the rough fractions, and keeping these latter inside a basket provided with fixed or rotating grids. In case of rotating grids, the screening of the material is performed by means of a rotating cylindrical basket, usually driven into rotating by means of a hydraulic rotary actuator carried by the bucket frame at opposite side from the bucket blade, that is usually provided with teeth for crushing the surface of the area to be excavated.

It is easily understood that the size of the openings of the grid of the rotating basket determine the granulometry (size) of the material kept in the basket; moreover, it is clearly apparent that, in order to filter the excavated material to obtain fractions of different sizes, it is necessary to perform a screening in more steps (fractionated screening), and this is possible only by changing the basket after having loaded the material, that has been subjected to a first screening step, into a hopper, so that to change the grid and replace it with a rougher one, to load the residual material in the basket, and so on until to have only the material of greater size than the grid of maximum screening size.

It is clearly understood that this operation requires very long times, and therefore high operating costs. Alternatively, it is possible to have a plurality of buckets, each of which provided with a basket with holes of given dimension, different than the dimension of the holes of the other baskets.

It is clearly understood that none of these two solutions is satisfactory, as it is necessary to have available many baskets or buckets, which means very high costs for both the solutions.

In view of the situation described above, it would be desirable to have available a screening bucket that, in addition to allow limiting and possibly overcoming the drawbacks of the prior art, defines a new standard for this kind of equipment, both from the viewpoint of the product and of the method of use, and therefore of the method performed for fractionated screening without losing material during the operation of the screening basket and eliminating the shutdown times necessary to replace the current basket with a basket with different screening capability.

### SUMMARY OF THE PRESENT INVENTION

The present invention relates to a screening bucket. In particular, the present invention relates to a screening bucket that can be actuated by means of an articulated arm of an earthwork machine. In more detail, the present invention relates to a screening bucket that can be actuated by means of an articulated arm of an earthwork machine in order to separate elements of different sizes from excavated material.

An object of the present invention is to provide a rotating screening basket for a screening bucket, allowing an adjustable screening of the heterogeneous material that has been excavated, in order to separate therefrom fractions of given size continuously definable at will.

According to the present invention a rotating screening basket for a screening bucket is provided, whose main features will be described in at least one of the appended claims.

A further object of the present invention is to provide a screening bucket provided with a rotating basket allowing to excavate heterogeneous material and to screening it in an adjustable manner, in order to separate therefrom fractions of given size continuously definable at will.

According to the present invention a screening bucket is provided, whose main features will be described in at least one of the appended claims.

A further object of the invention is to provide a method for continuous fractionated screening of incoherent excavated material by using a screening bucket.

According to the present invention a method is provided for screening incoherent excavated material by separating fractions of different size definable at will by using a screening bucket, wherein the main features of the method will be described in at least one of the appended claims. Moreover, in view of what above illustrated, a screening basket will be described below according to an embodiment, suitable for a screening bucket, the basket comprising a first cylindrical body having a central axis and a plurality of first holes, an actuating unit being provided for driving the first cylindrical body into rotation around the central axis; wherein the basket comprises a second cylindrical body housed inside the first cylindrical body; the second cylindrical body having a plurality of second holes, actuating means being associated with the first and second cylindrical bodies in order to move them with respect to each other so as to overlap the first and second holes.

An embodiment will be also described, wherein the first and second cylindrical bodies are so reciprocally associated, and the actuating means are so designed, that the rotation of one of the first and second cylindrical bodies through the actuating means results in a change in both the reciprocal position of the first and second cylindrical bodies along the longitudinal direction (parallel to the axis) and in their reciprocal position in rotational direction, wherein therefore, by means of the actuating means, one of the two cylindrical bodies is both translated and rotated with respect to the other body.

An embodiment will be also described, wherein the second cylindrical body, arranged inside the first cylindrical body, has a second diameter that is slightly smaller than a first diameter of the first cylindrical body and/or the first holes and the second holes have substantially the same width, so that, in use, when they perfectly overlap one another, the filtering capability exerted by the combination of the first and second cylindrical bodies is equal to the filtering capability of the first or second cylindrical body.

According to a further embodiment described herein, the basket comprises first centring means associated with the first cylindrical body in order to keep it coaxial with the central axis.

According to a further embodiment described herein, the second cylindrical body has a bottom closing it at the side of said centring means.

According to a further embodiment described herein, the centring means comprise a spoke-member coaxial with the central axis; the bottom portion being coupled to the spoke-member by means of a plurality of pins parallel to the central axis so as to be longitudinally movable with respect to the spoke-member.

According to a further embodiment described herein, the actuating unit comprises a first case supporting a second case in a freely rotatable manner; the first case and the second case being hydraulically coupled; the actuating unit and the actuating means are hydraulically coupled; the actuating means comprising a first linear actuator coaxial with the central axis to move the bottom axially with respect to the spoke-member.

According to a further embodiment described herein, each of the first and second holes is delimited by a first polygonal perimeter and by a second polygonal perimeter respectively, that are provided with first and second edges orthogonal to each other and having substantially constant width.

According to a further embodiment described herein, at least some first and second holes are square in shape and have substantially equal extension.

According to a further embodiment described herein, the case has, at the rear, hydraulic valves.

According to a further embodiment described herein, the actuating unit and the actuating means are hydraulically coupled; the actuating means comprising a second linear actuator arranged between the second cylindrical body and the first cylindrical body, so as to couple them together in a way that is axially fixed and can be angularly set at will within a given angular interval.

According to a further embodiment described herein, the second cylindrical body comprises a cylindrical element coupled to the second case in an axially and angularly rotatable way; the respective cylindrical element and second case having respective projections and recesses conjugated together so as to be, in use, reciprocally movable in a helical manner.

Below, a bucket will be described, provided with a basket according to any one of the embodiments illustrated, as well as a method for adjusting and/or setting a basket according to any one of the embodiments illustrated.

### BRIEF DESCRIPTION OF DRAWINGS

Further characteristics and advantages of the screening bucket, the screening basket and the method for fractionated screening according to the present invention will be more apparent from the description below, set forth with reference to the attached drawings, that illustrate some examples of embodiment, where identical or corresponding parts of the equipment are identified by the same reference numbers. In particular:

FIG. 1 is a front schematic perspective view of a first preferred embodiment of a screening bucket according to the present invention in a first operating configuration;

FIG. 2 is a back perspective view of the bucket of FIG. 1;

FIG. 3 is a side elevational view of the bucket of FIG. 1, with some parts removed for the sake of clarity;

FIG. 4 is a perspective view from the bottom of the bucket of FIG. 1, with some parts removed for the sake of clarity;

FIG. 5 is a longitudinal cross-section of a front perspective view of FIG. 1, in reduced scale and with some parts removed for the sake of clarity;

FIG. 6 is a back view of a bucket extracted from FIG. 1, with some parts removed for the sake of clarity;

FIG. 7 is a longitudinal cross-section of FIG. 6;

FIG. 8 is a perspective view from a rear viewpoint of a detail of FIG. 6, with some parts removed for the sake of clarity;

FIG. 9 is a longitudinal cross-section of FIG. 8;

FIG. 10 is a perspective view from the bottom of FIG. 1 in a preparatory configuration for removing the basket of FIG. 6, with some parts removed for the sake of clarity;

FIG. 11 is a schematic perspective view of a step of removing the basket of FIG. 10, with some parts removed for the sake of clarity;

FIG. 12 is a longitudinal view of a detail extracted from FIG. 3 in a second operating configuration;

FIG. 13 illustrates FIG. 12 in a third operating configuration;

FIG. 14 is a side elevational view of a detail extracted from FIG. 3 in a first operating configuration;

FIG. 15 illustrates FIG. 14 in a second operating configuration;

FIG. 16 illustrates FIG. 14 in a third operating configuration;

FIG. 17 is a schematic side elevational view of a second preferred embodiment of FIG. 1;

FIG. 18 is a schematic perspective view of FIG. 17 from a rear viewpoint, comprising a detail in enlarged scale;

FIG. 19 is a schematic perspective view of a third preferred embodiment of FIG. 1;

FIG. 20 is a schematic perspective view of a fourth preferred embodiment of FIG. 1 comprising two details in enlarged scale.

### DETAILED DESCRIPTION OF THE PRESENT INVENTION

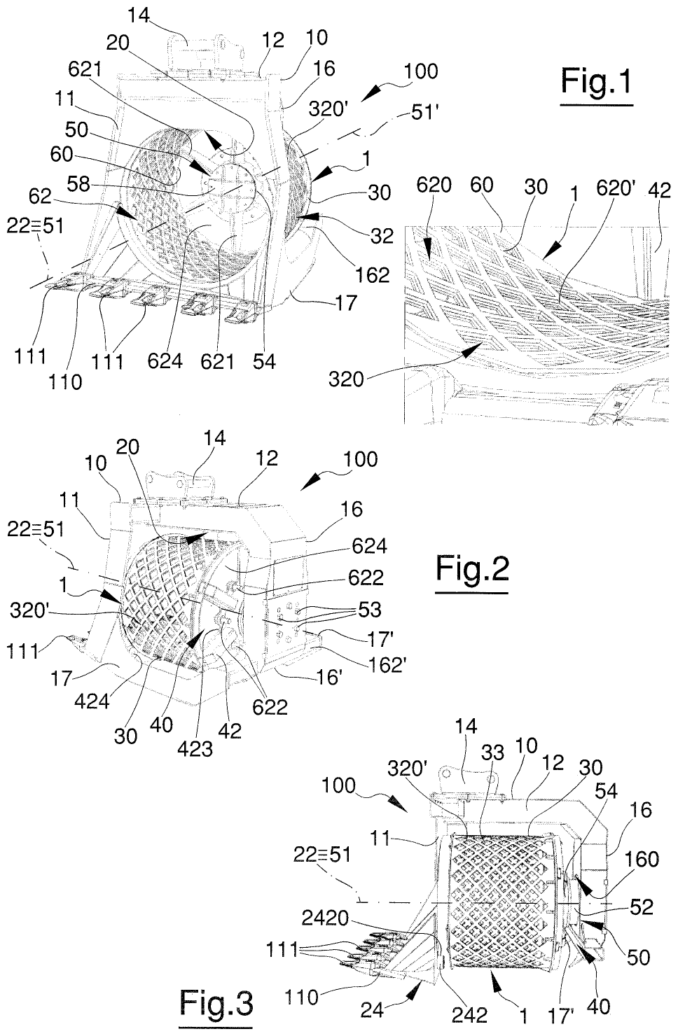

In FIG. 1, number 1 indicates, as a whole, a rotating screening basket 1 for a screening bucket 100, validly usable for fractionated screening of excavated heterogeneous material, in order to separate therefrom fractions of given size that can be defined at will continuously.

The bucket 100 (FIG. 11) is provided with a box-type frame 10 delimiting a space 20 that extends around a pivot axis 22 and is provided with respective support members 24 rotatable with respect to rotation axes parallel to the pivot axis 22. With reference to FIG. 2, the frame 10 further comprises a rear portion 16 substantially shaped like an overturned “T”, a lower part 16′ of which is arranged transversally to the pivot axis 22, extends downwards from the longitudinal portion 12 with two respective arms 162 and 162′ that are symmetrically inclined with respect to the longitudinal portion 12.

With reference to FIG. 1 again, and with particular reference to FIGS. 2-4, the frame 10 has a front portion 11 defining a round opening and is provided at the bottom with a blade 110, to which teeth 111 are applied, projecting anteriorly; a longitudinal portion 12, delimiting the space 20 at the top, extends at opposite side from the blade 110 and is provided at the top with a gripping member 14 usable to connect the bucket 100 to the end of an arm of an excavator known and therefore not shown. The frame 10 further comprises a pair of longitudinal members 17 and 17′, each of which extends from one of the arms 162 and 162′ up to the front portion 11 on the side of the blade 110. The pair of longitudinal members 17 and 17′ is spaced transversally to the pivot axis 22 by a distance that is slightly greater than an outer diameter of the basket 1, so as to delimit, together with the blade 110 and to the lower part 16′, an opening 170 through which the basket 1 can freely pass for being installed and removed. The back portion 16 has a housing 160 provided between the arms 162, 162′, and at least one roller 242 (or two rollers arranged symmetrically with respect to the pivot axis 22 on opposite sides), carried by the front portion 11 at opposite side with respect to the blade 110 facing the rear portion 16.

The space 20 is so shaped as to house the basket 1 and a respective roto-translatory actuating unit 50, for example of the fluid-dynamic type, better described below, coaxially with the axis 22. In particular, the actuating unit 50 comprises an actuator 50′, for instance an hydraulic actuator of the type CPR-8 produced by Baltrotors, which has an interface rotatable around a given axis and is designed to control a hydraulic device, for instance a hydraulic actuator associated with the same interface. The actuating unit 50 is provided with a first cylindrical case 52 (FIGS. 3-6) housing the actuator 50′ and coupled to the frame 10 in a fixed manner, in particular in the housing 160, by means of a plurality of screws 53 (shown in FIGS. 2, 14, 15 and 16), so as to keep the actuator 50′ with the central axis 51 coaxial with the pivot axis 22, as it will be better described below. The actuating unit 50 supports, in turn, the basket 1 in a rigid and selectively releasable manner. In particular, the first case 52 anteriorly supports a hub-shaped cylindrical portion 420 freely rotatable around the axis 51; this hub-shaped portion 420 supports, in turn, a second cylindrical case 54 in an axially slidable manner. Obviously, due to the features of the actuator type CPR-8 with which the actuator 50′ is constructed, this latter can be hydraulically supplied through a power circuit by means of in- and out-openings 55, only two of which are visible in FIGS. 14-16.

With particular reference to FIG. 1 and to the enlargement on the side, the basket 1 comprises a first cylindrical body 30 made of metal sheet or of any other functionally equivalent material. With reference to FIG. 1 again, the basket 1 comprises a second cylindrical body 60, at least partially housed in the first cylindrical body 30 and coaxially coupled to the first cylindrical body 30 in a longitudinally free and angularly fixed manner through a plurality of centring pins 622.

The first cylindrical body 30 is coaxial with the central axis 51 and is rigidly coupled to the spoke-member 42 extending radially from the hub-shaped portion 420. The cylindrical body 30 is therefore pivoted to the frame 10 through the centring unit 40 provided with the spoke-member 42 and with the hub-shaped portion 420, coaxially with the central axis 51. The centring unit 40 is so designed as to be kept coaxial with the pivot axis 22 cooperating with each roller 242 having a respective peripheral portion 2420 externally adjacent to the same first cylindrical body 30. Therefore, each roller 242 is arranged at a radial distance from the pivot axis 22 that is quiet equal to an outer radius of the first cylindrical body 30. Therefore, the spoke-member 42 of the centring unit 40 keeps the first cylindrical body 30 and the second cylindrical body 60 coaxial with the axis 22/51.

The cylindrical body 30 has a plurality of first holes 32 (square-shaped in the embodiment illustrated, but they may have different shape), better shown in FIG. 3, for example moulded and arranged according to rectilinear directrixes wound on the cylindrical mantel 33 of the first cylindrical body 30 similarly to the generatrixes of lined surfaces, according to a base angle of 45° with respect to the central axis 51 and distributed at a given angular pitch. Thanks to the fact of geometrically distributing the holes 32 as described above, the holes 32 are arranged longitudinally at a first given pitch P1 and longitudinal rows of holes 32, that longitudinally overlap one another, are substantially displaced with respect to one another by a length that is slightly greater than a half diagonal of a hole 32.

Similarly to the first cylindrical body, the second cylindrical body 60, provided with a bottom 624, reinforced anteriorly by means of a plurality of ribs 621, has a plurality of second holes 62 arranged, like the first holes 32, on the first cylindrical body 30, and therefore longitudinally at a second given pitch P2. Therefore, the first and second holes 32/62 are respectively delimited by a first square perimeter 320 and by a second square perimeter 620, provided with first and second edges 320′ and 620′ that are orthogonal to each other and have constant width.

The second cylindrical body 60 is arranged inside the first cylindrical body 30 and has a second diameter D2 that is slightly smaller than a first diameter D1 of the first cylindrical body 32; the first holes 32 and the second holes 62 have substantially the same width, so that, in use, when they overlap each other, the filtering capability resulting by combining the first and second cylindrical bodies 30/60 is equal to the filtering capability of the single first or second cylindrical body 30/60, so as to act together as the basket 1 would comprise only one of them (one of the two cylindrical bodies 30 and 60).

Each of the first and second holes 32/62 is delimited by a first square perimeter 320 and by a second square perimeter 620, polygonal and delimited by first and second edges that are orthogonal to each other and have constant width.

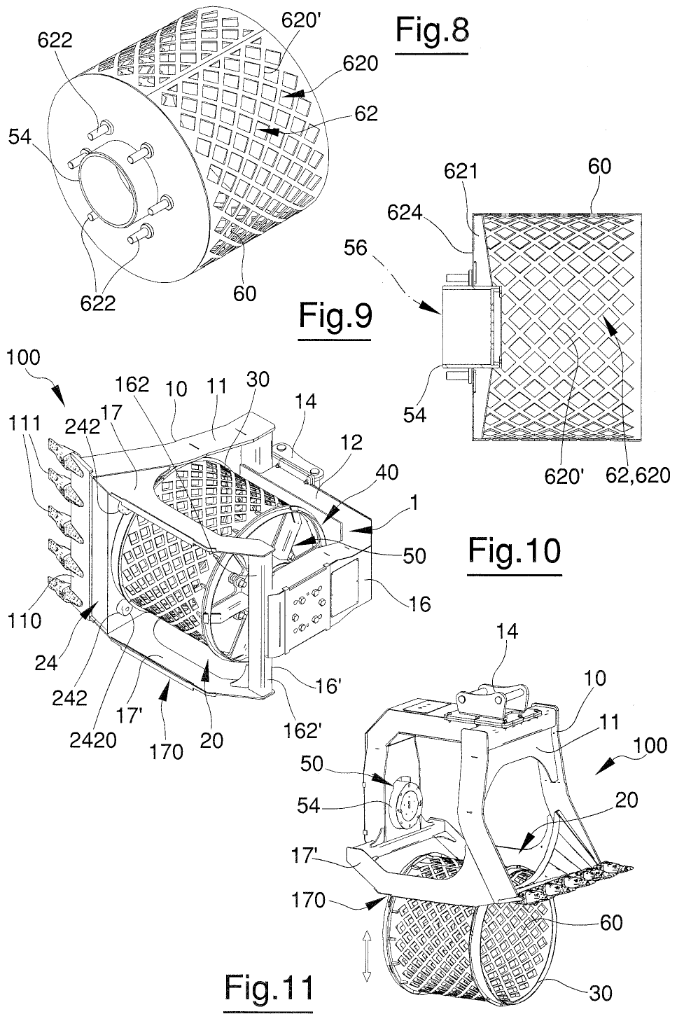

In view of the above description, the integral coupling between the second cylindrical case 54 and the hub-shaped portion 420 of the spoke-member 42 allows driving the first cylindrical body 30 (and therefore the second cylindrical body 60) into rotation with respect to the frame 10. Again with reference to FIG. 5, the second cylindrical case 54 extends beyond the hub-shaped portion 420 crossing the spoke-member 42 and contains a fluid-dynamic linear actuator 56 supplied by the actuator 50′ through a pipe 50″, shown only in FIG. 5. The actuator 56 is carried coaxial with the central axis 51 and is arranged between the spoke-member 42 and the bottom 624. In particular, the linear actuator 56 has a stem 57 rigidly connected to a head 58 of the second cylindrical body 60 delimiting anteriorly the case 54, and is rigidly and coaxially coupled to a bottom 624. In view of the above description, the head 58 together with the second cylindrical case 54, with the second cylindrical body 60 and with the spoke-member 42, is longitudinally movable with respect to the frame 10 and is able to rotate together with the first cylindrical body 30. it should be noted that, with reference to FIG. 8, the bottom 624 carries, at the rear, centring pins 622 parallel to the central axis 51 and engaging a plurality of holes 422 (FIG. 6) provided radially at given angular pitch in a ring 423 of the spoke-member 42. In view of the above description, the second cylindrical body 60 is angularly fixed with respect to the first cylindrical body 30 around the central axis 51 through the spoke-member 42.

The bottom 624 of the second cylindrical body 60 has the function of protecting the actuating unit 50 against the material contained in the basket 1 and each roller 242 is coupled to the front portion 11 in a releasable manner, so that the basket 1 can freely access the space 20 from the bottom through the opening 170 for mounting/removing operations.

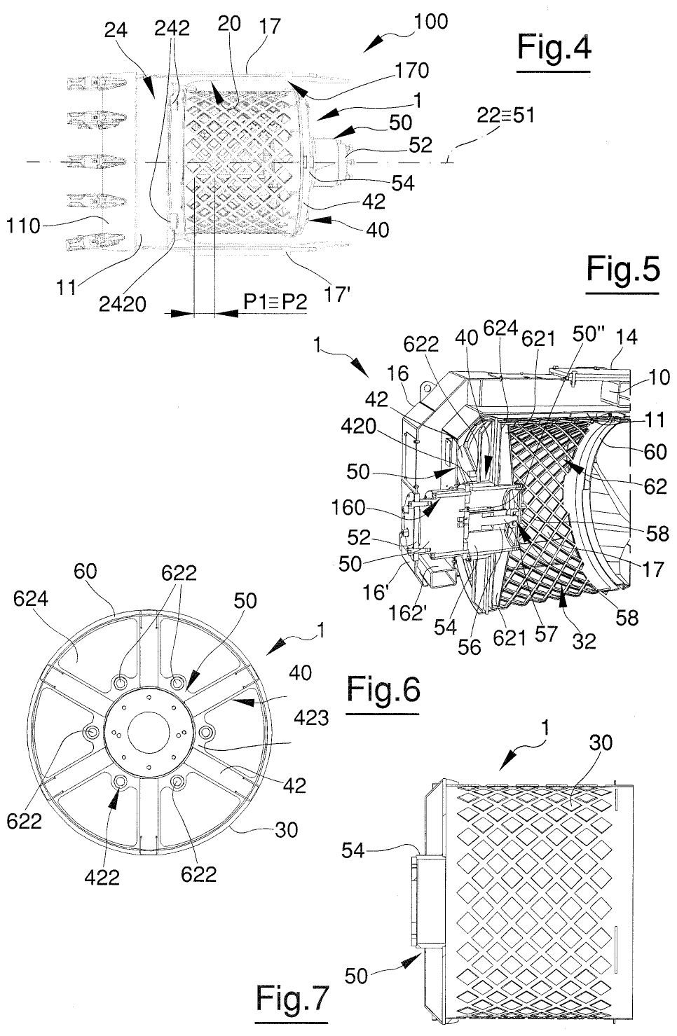

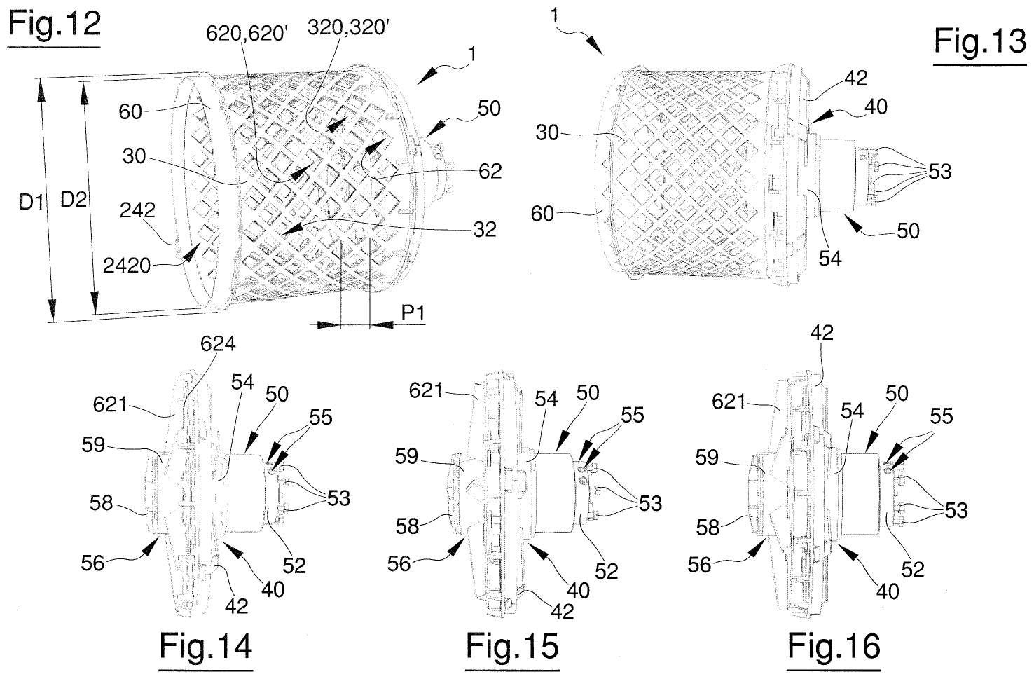

The operation of the basket 1 and of the bucket 100 is clearly apparent from the description above and does not require further explanations. However, it is useful to specify that, with references to FIGS. 4 and 11-16, where the basket is illustrated with the respective first and second cylindrical bodies 30 and 60 arranged in different relative positions, and, in particular, with the respective first and second edges 320′ and 620′ completely overlapping each other (FIG. 4) and therefore with the holes 32 and 62 completely free to allow the passage of elements of maximum size, the basket 1 is in maximum screening configuration; with the respective first and second edges 320′ and 620′ partially overlapping each other, and therefore with the holes 32 partially closed by the edges 620′ of the second cylindrical body 60, the basket 1 is in intermediate screening configuration (FIG. 12); with the respective first and second edges 320′ and 620′ partially overlapping each other, and therefore with the holes 32 closed in a cross-like manner by the edges 620′ of the second cylindrical body 60 (FIG. 13), the basket 1 is in minimum screening configuration. FIGS. 14, 15 and 16 illustrate the linear actuator 56 with the head 58 thereof keeping the bottom 624 in the various positions corresponding to the configurations of the basket 1 described above, in maximum, intermediate and minimum screening configuration.

Lastly, it is clearly apparent that variants and modifications can be done to the basket 1 and the screening bucket 100 comprising it, described and illustrated herein, without however departing from the protective scope of the invention.

For example, it should be specify that the holes 32 and 62 of the first and second cylindrical bodies 30 and 60 may have the same shape, as well as different shape according to the operating needs. Usually, without however limiting the protective scope of the invention, these holes may have round, triangular, pentagonal shape.

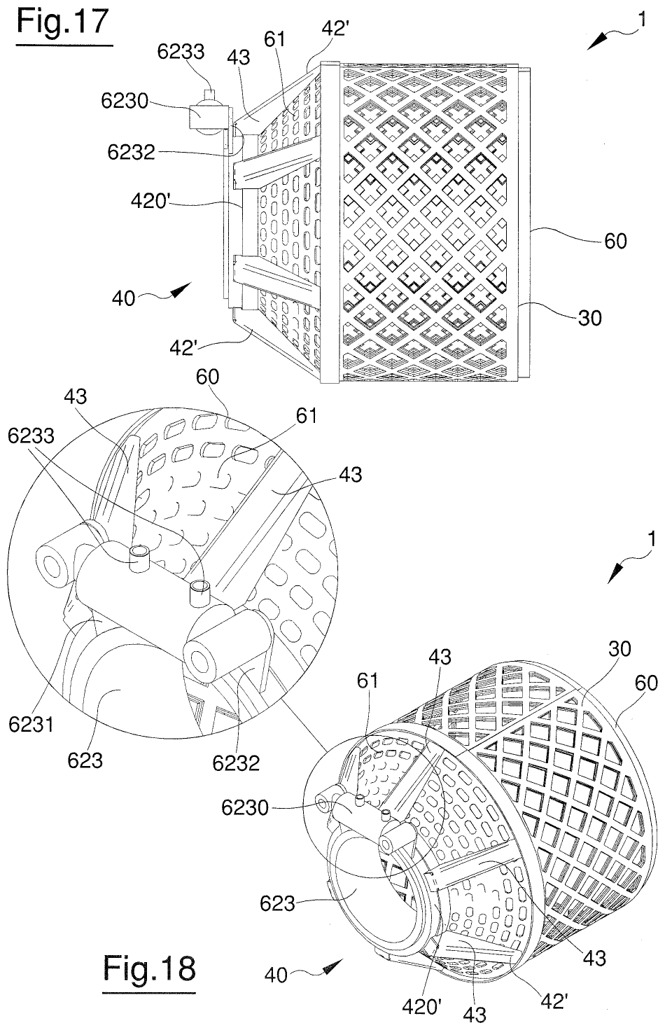

Moreover, the relative motion between the first and second cylindrical bodies 30 and 60 for adjusting the overlapping degree of the respective first and second holes, and therefore the screening degree of the basket 1 resulting from the different overlapping degree of the holes 32 and 62, may be also different than an axial movement, as it is shown in FIGS. 17 and 18, where the two components always have axial-symmetrical shape concentric to the axis 51 but at least the second cylindrical body 60 has a truncated-conical end portion 61 contained inside the spoke-member 42′, modified so as to have respective inclined arms 43 facing the truncated-conical portion 61. In this case, the second cylindrical body 62 has a hub 623 that can be keyed on the first case 52 and the first cylindrical body 30 is coupled through a hub 420′ of its spoke-member 42′ to the hub 623 in an axially fixed an angularly rotatable manner. Moreover, the hub 623 and the spoke-member 42′ are coupled together on the respective cylindrical peripheries by means of a linear actuator 6230 arranged between brackets 6231 and 6232 extending radially from the hub 623 and from the spoke-member 42′ respectively. This allows to make the first and the second cylindrical bodies 30 and 60 coupled in an axially fixed and angularly adjustable manner within a given angular interval. The actuator 6230 may be of the fluid-dynamic type as in FIG. 18, without however limiting the scope of the present invention, and has hydraulic coupling holes 6233 for being actuated. It is easily understood that in this case the second cylindrical body 60 drives the first cylindrical body 32 through the actuator 6230.

The truncated-conical portion may be replaced with a flat portion, provided with holes of any shape.

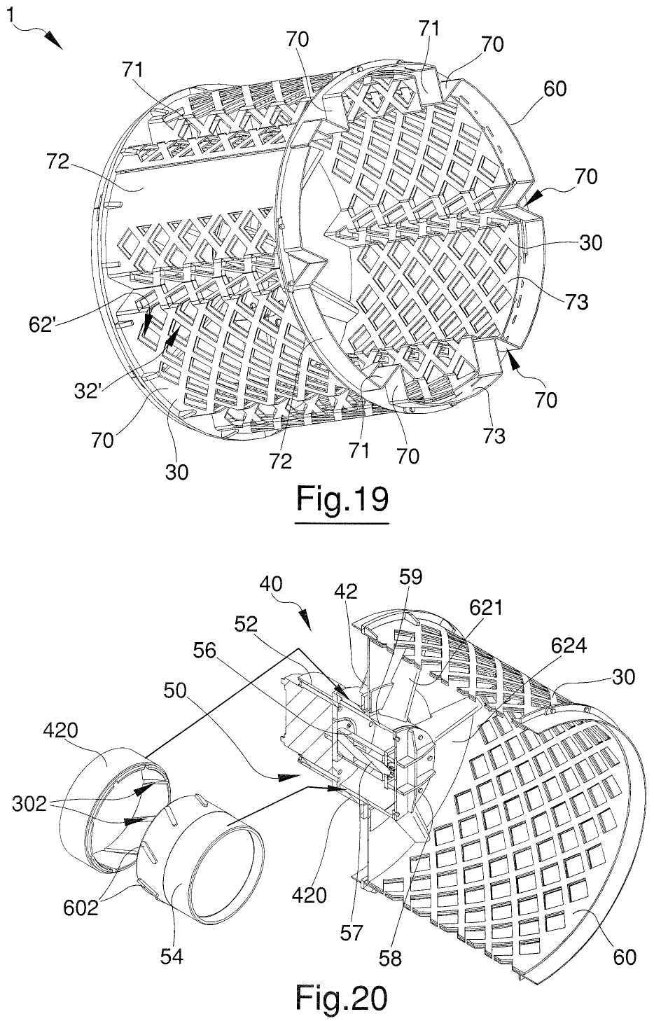

With particular reference to FIG. 19, a third embodiment of the basket 1 is illustrated, wherein the screening capability of the basket 1, i.e. the overlapping degree of the first and second holes 32 and 62, is controlled through the linear actuator 56, but the first cylindrical body 30 and the second cylindrical body 60 are replaced with a first prismatic body 30′ and a second prismatic body 60′ respectively. These two bodies are geometrically similar in order to be coupled so as to be able, like the first and the second cylindrical bodies 30 and 60, to longitudinally slide with respect to each other, but they are so shaped as to obtain V-shaped portions, indicated with 70 and 71 respectively, that arranged at given angular pitch along the cylindrical extension of both the bodies. Therefore, in this embodiment each first and second body 30/60 can be geometrically reproduced by projecting, along the axis 51, a polygonal shape having round segments 72 and 73, concentric with the axis 51, alternated with V-shaped portions 70 and 71 arranged radially. The holes 32′ and 62′ provided in the first prismatic body 30′ and in the second prismatic body 60′ are equal to the first holes 32 and to the second holes 62, and are therefore delimited by rectangular perimeters. In this case it is easy to understand that the basket 1 of FIG. 19 is associated with an auxiliary mechanical constraint given from the plurality of V-shaped portions 72 and 73 of the relative angular position of the respective components that, in use, have a screening function, in addition to that given by the linear actuator 56, having the function of reducing the torsional stresses of the linear actuator 56 instead of, or in addition to, the centring pins 622.

With reference to FIG. 20, a further embodiment of the basket 1 is illustrated, wherein the first cylindrical body 30 and the second cylindrical body 60 are substantially the same in shape and dimension as those of FIGS. 1-16, but the type of relative movement is different, as it is not only linear/axial or rotatory, but roto-translatory. In order to achieve this, the first cylindrical body 30 and the second cylindrical body 60 respectively have the hub-shaped portion 420 and the second case 54 provided with respective projections 302 and recesses 602 conjugated to one another so as to be, in use, reciprocally movable in a helical manner. Obviously, the head 58 is coupled to the stem 57 of the linear actuator 56 in an axially fixed and freely rotatable manner, so that to the relative axial movement between the first cylindrical body 30 and the second cylindrical body 60 controlled by the stem 57 a rotary motion corresponds, whose combination produces a relative helical motion of the first and second cylindrical bodies 30 and 60. In any case, it should be specified that a screening bucket constructed like the bucket 100, provided with the basket 1 produced according to any one of the embodiments described and illustrated above, represents a significant progress with respect to the prior art, thanks to which it is possible to overcome the drawbacks of the prior art, as it allows fractionated screening of the excavated material without losing material during operation and eliminating the shutdown times necessary to replace the screening basket with a basket of different screening size, thus allowing high production savings.

1-16. (canceled)

17. Screening basket (1) for a screening bucket (100); said basket (1) comprising a first cylindrical body (30) having a central axis (51) and a plurality of first holes (32) arranged longitudinally at a first given pitch (P2); a fluid-dynamic actuating unit (50) being provided to rotate said first cylindrical body (30) around said central axis (51); said basket (1) comprising a second cylindrical body (60) arranged inside said first cylindrical body (30) and coupled to said first cylindrical body (30); said second cylindrical body (60) having a plurality of second holes (62) arranged longitudinally at a second given pitch (P2) and facing said first holes (32); actuating means (56)(6230) being associated with said first and second cylindrical bodies (30)(60) to move them relative to each other; characterized in that said second cylindrical body (60) is arranged inside said first cylindrical body in a longitudinally and angularly free manner, and in that said actuating means (56) (6230) are so designed, that the rotation of one of the first and second cylindrical bodies (30) (60) through said actuating means (56) (6230) results in a change in both the reciprocal position of the first and second cylindrical bodies along the longitudinal direction parallel to said central axis (51) and in their reciprocal position in rotational direction, wherein therefore, by means of the actuating means, one of the two cylindrical bodies (30) (60) is both translated and rotated with respect to the other cylindrical body (30) (60).

18. Basket according to claim 17, characterized in that said second cylindrical body (60) has a second diameter (D2) that is slightly smaller than a first diameter (D1) of said first cylindrical body (32); said first holes (32) and said second holes (62) having substantially the same width, so that, in use, when they overlap each other, the filtering capability exerted by the combination of said first and second cylindrical bodies (30)(60) is equal to the filtering capability of the first or second cylindrical body (30)(60).

19. Basket according to claim 17, characterized by comprising first centering means (40) associated with said first cylindrical body (30) to keep it coaxial with said central axis (51).

20. Basket according to claim 19, characterized in that said second cylindrical body (60) has a bottom (624) closing it at the side of said centering means (40).

21. Basket according to claim 20, characterized in that said centering means (40) comprise a spoke-member (42) coaxial with said central axis (51); said bottom portion (624) being coupled to said spoke-member (42) by means of a plurality of pins (622) parallel to said central axis (51) so as to be longitudinally movable with respect to said spoke-member (42).

22. Basket according to claim 21, characterized in that said actuating unit (50) comprises a first case (52) supporting a second case (54) in a freely rotatable manner; said first case (52) and second case (54) being hydraulically coupled to each other; said actuating unit and said actuating means (56) being hydraulically coupled to each other; said actuating means (56) comprising a first linear actuator (56) coaxial with said central axis (51) to move said bottom (624) axially with respect to said spoke-member (42).

23. Basket according to claim 17, characterized in that each of said first and second holes (32) (62) is delimited by a first polygonal perimeter (320) and by a second polygonal perimeter (620) provided with first and second edges (320′) (620′) that have substantially constant width and are orthogonal to each other.

24. Basket according to claim 23, characterized in that said first and second holes (32) (62) are square in shape and have substantially equal extension.

25. Basket according to claim 22, characterized in that said case (52) has, at the back thereof, hydraulic valves (520).

26. Basket according to claim 17, characterized in that said actuating unit (50) and said actuating means (56) are hydraulically coupled to each other; said actuating means (6230) comprising a second linear actuator (6230) arranged between said second cylindrical body (60) and said first cylindrical body (30) to couple them together in a way that is axially fixed and can be angularly set at will within a given angular interval.

27. Basket according to claim 22, characterized in that said second cylindrical body (60) comprises a cylindrical element (420) coupled to said second case (54) in an axially and angularly rotatable way; the respective cylindrical element (420) and second case (54) having respective projections (302) and recesses (602) conjugated together so as to be, in use, reciprocally movable in a helical manner.

28. Scanning bucket (100) provided with a box-type frame (10) having a space (20) that extends around a pivot axis (22) and is provided with rotatable support means (24); characterized in that said space (20) is designed to house a screening basket (1), comprising a first cylindrical body (30) having a central axis (51) and a plurality of first holes (32) arranged longitudinally at a first given pitch (P2); a fluid-dynamic actuating unit (50) being provided to rotate said first cylindrical body (30) around said central axis (51); said basket (1) comprising a second cylindrical body (60) arranged inside said first cylindrical body (30) and coupled to said first cylindrical body (30); said second cylindrical body (60) having a plurality of second holes (62) arranged longitudinally at a second given pitch (P2) and facing said first holes (32); actuating means (56)(6230) being associated with said first and second cylindrical bodies (30)(60) to move them relative to each other; characterized in that said second cylindrical body (60) is arranged inside said first cylindrical body in a longitudinally and angularly free manner, and in that said actuating means (56) (6230) are so designed, that the rotation of one of the first and second cylindrical bodies (30) (60) through said actuating means (56) (6230) results in a change in both the reciprocal position of the first and second cylindrical bodies along the longitudinal direction parallel to said central axis (51) and in their reciprocal position in rotational direction, wherein therefore, by means of the actuating means, one of the two cylindrical bodies (30) (60) is both translated and rotated with respect to the other cylindrical body (30) (60), wherein the scanning bucket is provided with a respective central axis (51); said rotatable support means (24) being designed to support said basket (1) so as to keep said respective central axis (51) coaxial with said pivot axis (22).

29. Bucket according to claim 28, characterized in that said frame (10) has an annular front portion (11) provided, at the bottom, with a blade (110); a longitudinal portion (12), delimiting, at the top, said space (20), extends at opposite side with respect to said blade (110) and is provided with a gripping member (14); a Y-shaped or T-shaped rear portion (16), arranged transversally to said pivot axis (22), extends downwards from said longitudinal portion (12) with two respective arms (162, 162′), symmetrically inclined with respect to said longitudinal portion (12); and a pair of longitudinal members (17, 17′), each of which extends from one said arm (162)(162′) to said front portion at the side of said blade (110); said pair of longitudinal members (17, 17′) being spaced, transversally to said pivot axis (22), by a distance that is slightly greater than an outer diameter of said basket (1).

30. Bucket according to claim 29, characterized in that said rotatable support means (24) comprise at least one rolling roller (242) carried parallel to said front portion (11) at opposite side from said blade (110) in a position facing said rear portion (16) and with a peripheral portion (2420) thereof that is externally tangential to said first cylindrical body (30).

31. Bucket according to claim 30, characterized in that each said roller (242) is coupled to said front portion (11) in a removable manner, so that said space (20) can be freely accessed at the bottom from said basket (1) to assembling/disassembling operations.

32. Basket according to claim 23, characterized in that said actuating unit (50) and said actuating means (56) are hydraulically coupled to each other; said actuating means (6230) comprising a second linear actuator (6230) arranged between said second cylindrical body (60) and said first cylindrical body (30) to couple them together in a way that is axially fixed and can be angularly set at will within a given angular interval.
